(19) United States
(12) Patent Application Publication
(10) Pub. No.: US 2005/0248613 A1
(43) Pub. Date: Nov. 10, 2005

(54) Head maintenance device and ink jet printer incorporating the same

(75) Inventor: Masashi Fujikawa, Nagano (JP)

Correspondence Address: NIXON & VANDERHYE, PC, 901 NORTH GLEBE ROAD, 11TH FLOOR, ARLINGTON, VA, 22203, US

(73) Assignee: Seiko Epson Corporation, Tokyo (JP)

(21) Appl. No.: 11/124,390

(22) Filed: May 9, 2005

(30) Foreign Application Priority Data
May 7, 2004 (JP) 2004-138557

(51) Int. Cl. B41J 2/165

(52) U.S. Cl. 347/33

(57) ABSTRACT

A maintenance device for an ink jet printing head includes a first wiper that wipes a nozzle formation face of the ink jet printing head. The first wiper extends in a direction orthogonal to a reciprocating direction of the printing head and is movable between a first position being away from the nozzle formation face and a second position being contact with the nozzle formation face. A second wiper is movable across the first wiper to wipe foreign matter from the first wiper.

### BACKGROUND OF THE INVENTION

The present invention relates to a head maintenance device which cleans a nozzle formation face of a print head using a wiper, and an ink jet printer incorporating the same.

Generally, an ink jet printer is configured so that a print head, which is mounted on a carriage which can reciprocate, ejects ink droplets from a plurality of nozzles onto a predetermined position on a printing medium to perform printing.

However, on the nozzle formation face of the print head, foreign matter such as ink or dirt can be adhered at the time of printing. Therefore, the print head needs to be cleaned outside a printed region in order to appropriately maintain it. As such a cleaning process, a wiping process is known where a plate-shaped wiper made of rubber is disposed in a position where the wiper comes in contact with the nozzle formation face of the print head. The print head is moved so that the wiper is bent and contacted with the nozzle formation face. As a result, foreign matter is wiped out from the nozzle formation face of the print head.

In addition, in such a wiping process, when the wiper wipes the nozzle formation face of the print head, foreign matter is adhered to the wiper.

Therefore, if the nozzle formation face is wiped again by the wiper to which foreign matter is adhered, the foreign matter intrudes into the nozzle so that the nozzle becomes clogged or the meniscus within the nozzle is broken. As a result, the problem of dot omission can occur.

Consequently, a maintenance device (head maintenance device) is known having a configuration where a remover (sub wiper) for wiping dirt off the wiper is provided on the print head. The print head is stopped in a predetermined position, and the wiper moves to a position where the wiper is engaged with the remover, so that the dirt of the wiper is wiped by a scraping section of the remover (cf., Japanese Patent Publication No. 2003-1835A, for example).

In the maintenance device disclosed in this publication, however, the scraping section of the remover needs to be elastically contacted in the widthwise direction of the plate-shaped wiper having a predetermined width corresponding to the nozzle formation face of the print head, and it is difficult to uniformly contact the scraping section having a relatively large width with the wiper. Since scraping is unevenly performed, it is impossible to completely remove the foreign matter. Consequently, in order to completely remove foreign matter adhered to the wiper, a high processing accuracy of the scraping section and a high positioning accuracy of the remover are required, which causes an increase in the manufacturing cost.

In addition, since the remover is provided on the print head, a paper can be stained by the foreign matter adhered to the remover when the print head moves.

### SUMMARY OF THE INVENTION

It is therefore an object of the invention to provide a head maintenance device, which can reliably remove extraneous matter adhered to a wiper at low cost, and to provide an ink jet printer incorporating such a head maintenance device.

In order to achieve the above object, according to the invention, there is provided a maintenance device for an ink jet printing head which is reciprocated in a first direction, comprising:
a first wiper positionable to wipe a nozzle formation face of the ink jet printing head, the first wiper extending in a second direction orthogonal to the first direction and being movable in a third direction orthogonal to the first direction and the second direction between a first position being away from the nozzle formation face and a second position being contact with the nozzle formation face; and
a second wiper movable in the second direction to wipe off foreign matter from the first wiper.

With the above configuration, the second wiper moves in the widthwise direction of the first wiper to scrape extraneous matter adhered to the first wiper. Therefore, a scraping width of the second wiper does not need to match an entire width of the first wiper corresponding to the nozzle formation face and can be made narrow. Consequently, even if the second wiper is provided with high manufacturing accuracy and high positioning accuracy, the second wiper can be uniformly brought into contact with the first wiper, so that uneven scraping hardly occurs. Therefore, manufacturing costs can be reduced, and the extraneous matter of the wiper can be reliably removed.

Preferably, the maintenance device further comprises:
a holder movable in the third direction while holding the first wiper;
an arm, a first end of which is pivotably supported on the holder and a second end of which supports the second wiper; and
an interlocking mechanism, which pivots the arm in the second direction in accordance with the movement of the holder in the third direction.

In this case, the configuration for moving the second wiper is achieved by a compact and simple mechanism.

In addition, since the second wiper wipes the first wiper before and after the wiping operation of the first wiper, the first wiper is always kept clean.

Preferably, the maintenance device further comprises an ink absorber, disposed adjacent the second wiper to absorb foreign matter wiped from the first wiper by the second wiper.

In this case, the second wiper can prevent scraped foreign matter from being scattered into and dirtying the maintenance device.

Preferably, a longitudinal width of the second wiper is less than a width of the first wiper in the second direction.

Preferably, the second wiper wipes the first wiper when the first wiper moves from the first position to the second position.

Alternatively, the second wiper wipes the first wiper when the first wiper moves from the second position to the first position.

According to the invention, there is also provided an ink jet printer, comprising:
an ink jet printing head, reciprocated in a first direction and having a nozzle formation face; and
a maintenance device comprising:
   a first wiper positionable to wipe the nozzle formation face, the first wiper extending in a second direction orthogonal to the first direction and being movable in a third direction orthogonal to the first direction and the second direction between a first position being away from the nozzle formation face and a second position being contact with the nozzle formation face; and
a second wiper movable in the second direction to wipe off foreign matter from the first wiper.

Preferably, a longitudinal width of the second wiper is less than a width of the first wiper in the second direction.

According to the invention, there is also provided a maintenance device for wiping a nozzle formation face of an ink jet printing head comprising:
a first wiper movable between a first position being in a path of the nozzle formation face and a second position being away from the path; and
a second wiper disposed adjacent the first wiper and reciprocatable from a third position on one side of the first wiper, across the first wiper, to a fourth position on an opposite side of the first wiper,
wherein the first and second wipers are coupled in a dependent relationship such that when the first wiper is moved from the second position to the first position, the second wiper is pivoted from the third position across the first wiper to the fourth position.

The maintenance device may additionally include:
a holder supporting the first wiper, the holder being movable within a wiper housing to move the first wiper between the first position and the second position, wherein a wall of the wiper housing comprises a cam portion therein; and
a pivot arm pivotally attached at a first end to the holder and supporting the second wiper at a second end, the pivot arm comprising an engagement projection disposed between the first and second ends, wherein the engagement projection is disposed in the cam portion.

A wiper driving mechanism may be coupled with the holder, the wiper driving mechanism driving the holder within the wiper housing to move the first wiper between the first position and the second position. The wiper driving mechanism comprises a pivot lever pivotable about a pivot end and coupled with the holder at an opposite end, the pivot lever including a cam follower engaged with a cam gear having cam surfaces, wherein the cam gear is rotatable to vary a position of the cam follower on the cam surfaces, thereby driving the holder to move the first wiper between the first position and the second position.

Preferably, a longitudinal width of the second wiper is less than a longidudinal width of the first wiper.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of an ink jet printer incorporating a head maintenance device according to one embodiment of the invention;

FIG. 2 is a top perspective view of the head maintenance device;

FIG. 3 is a bottom perspective view of the head maintenance device;

FIG. 4 is a side view of the head maintenance device;

FIG. 5 is a front view of the head maintenance device;

FIGS. 6A and 6B are views for explaining a position of a sub wiper when a wiper is placed in a retreating position;

FIGS. 7A and 7B are views for explaining a position of the sub wiper when the wiper is moved to a wiping position; and

FIGS. 8A and 8B are views for explaining a position of the sub wiper when the wiper is placed in the wiping position.

### DETAILED DESCRIPTION OF THE INVENTION

Embodiments of the invention will be described below in detail with reference to the accompanying drawings.

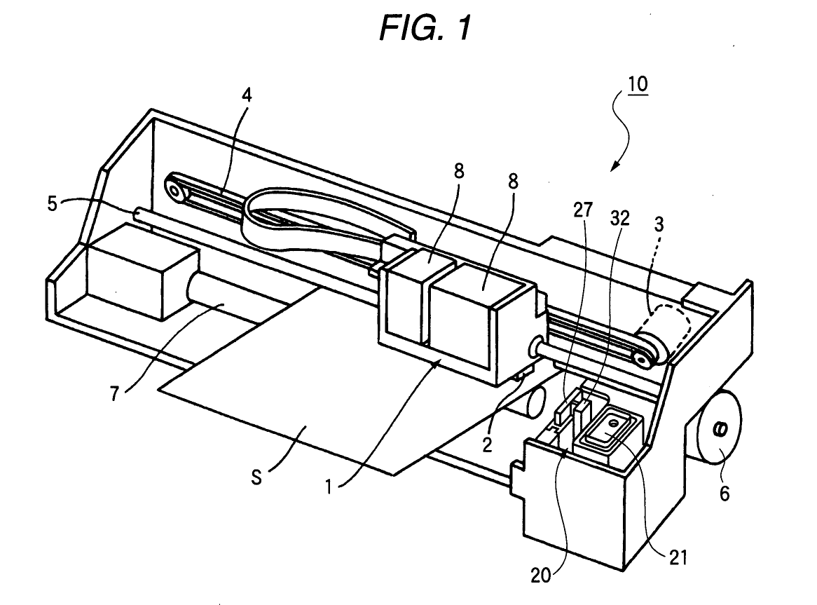

As shown in FIG. 1, an ink jet printer 10 comprises a transporting roller 7 which is rotated by a paper feeding motor 6 to carry a printing sheet S and a print head 2 mounted on a carriage 1.

The carriage 1, which detachably supports an ink cartridge 8, reciprocates along a guide shaft 5 in the widthwise direction of the printing sheet S by a timing belt 4, which is rotated by a carriage driving motor 3.

A head maintenance device 20 is positioned outside of a print region at a home position of the carriage 1. The head maintenance device 20 wipes dirt on a nozzle formation face 2a of the print head 2, performs capping for preventing an ink nozzle from being clogged, and sucks the thickened ink from an ink nozzle.

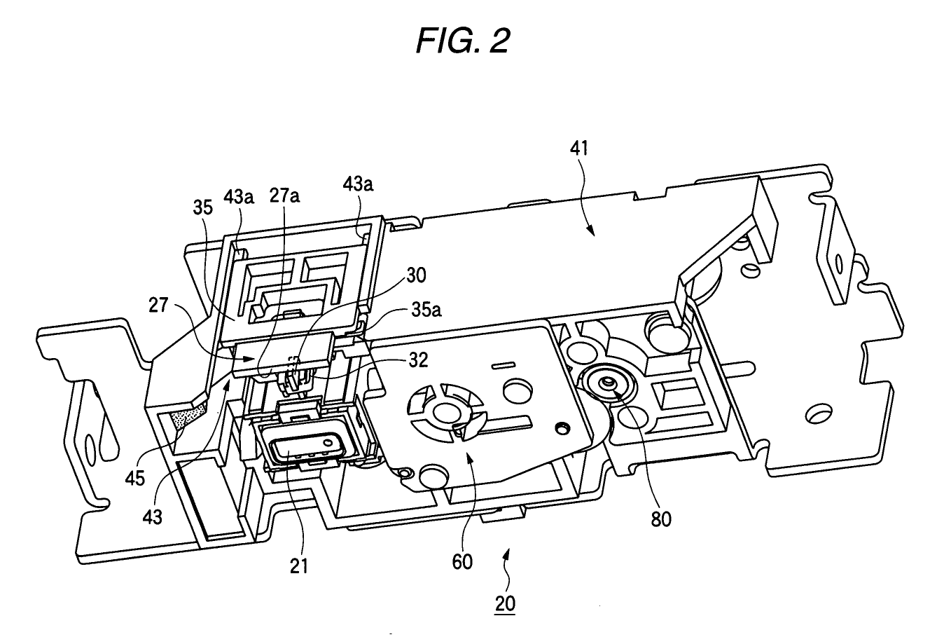

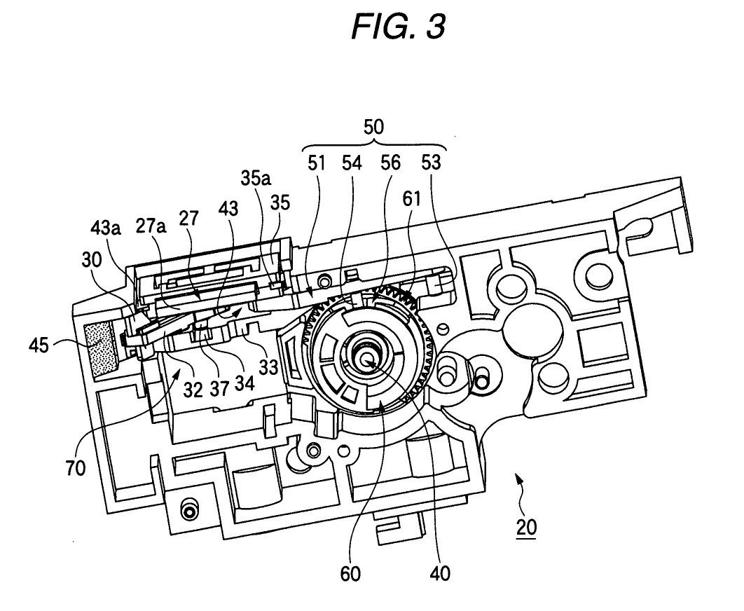

As shown in FIGS. 2 and 3, the head maintenance device 20 includes a head cap 21 for sealing the nozzle formation face 2a of the print head 2, a wiper 27 for wiping the nozzle formation face, a sub wiper 30 for scraping extraneous matter adhered to the wiper 27, and an ink sucking device 40 for sucking remaining ink from the head cap 21.

The head cap 21, the wiper 27, the sub wiper 30 and the ink sucking device 40 are driven by a pump motor 80 through a power transmission mechanism 60. These respective components are housed in a housing 41 which is detachable on the main body of the printer.

The wiper 27, the sub wiper 30, and the head cap 21 are provided parallel to each other in the reciprocating direction of the carriage 1, and the ink sucking device 40 is arranged in the backside of the head cap 21 in the printer (the left-hand side in FIG. 2).

The power transmission mechanism 60 is arranged so that the head cap 21, the wiper 27, the sub wiper 30, and the ink sucking device 40 can operate together.

In other words, the power transmission mechanism 60 is configured to advance and retreat the head cap 21 and the wiper 27 by the driving force from the pump motor 80 in a direction orthogonal to the reciprocating direction (the up and down direction in FIG. 2) of the print head 2. Further, the power transmission mechanism 60 reciprocates the sub wiper 30 in the widthwise direction of the wiper 27, which is substantially orthogonal to the moving direction of the wiper 27 and operates the ink sucking device 40.

Moreover, with regard to the head cap 21 and the ink sucking device 40, components having a general configuration can be used, and a detailed description of the components will be omitted in the present embodiment.

The wiper 27 of the present embodiment is held by a wiper holder 35, as shown in FIGS. 2 to 5. The wiper 27 is formed of rubber in a substantially rectangular plate, of which the tip end 27a contacts the nozzle formation face 2a of the print head 2 to scrape it. Accordingly, the wiper 27 can wipe out foreign matter such as ink adhered to the nozzle formation face 2a. Further, according to the type of ink, the wiper 27 may be formed of flexible plastic or the like.

When an engagement groove 35a formed in edges of both sides of the wiper 35 is engaged to a fitting projection 43a of a wiper housing section 43, the wiper holder 35 accommodated in the wiper housing section 43 of the housing 41 freely advances and retreats in the direction orthogonal to the reciprocating direction of the print head 2.

The wiper holder 35 advances and retreats with respect to the wiper housing section 43 by a wiper driving mechanism 50, which is operated by the power transmission mechanism 60.

As shown in FIGS. 3 through 8B, the wiper driving mechanism 50 includes a pivot lever 51 which is supported in the housing 41 so as to freely pivot about a spindle 53.

In the middle of the pivot lever 51, a follower projection 54 projects, and is driven and guided by a cam section 56 formed in a cam gear 61 of the power transmission mechanism 60, so that the end of the pivot lever 51 opposite the spindle 53 pivots up and down.

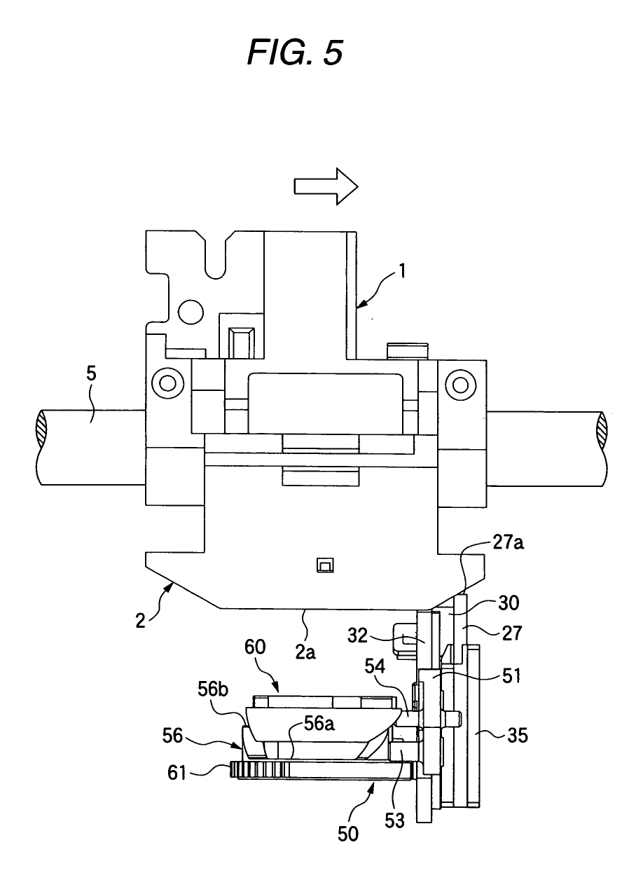

As shown in FIG. 5, the cam section 56 is a ring-shaped cam face formed in one face (upper face in FIG. 5) of the cam gear 61 and includes a first cam face 56a which positions the pivot lever 51 in a retreating position and a second cam face 56b which positions the pivot lever 51 in a wiping position. Accordingly, the follower projection 54 engaged with the cam section 56 is driven on the cam face with the rotation of the cam gear 61 to be displaced in the direction of the rotation axis of the cam gear 61, so that the pivot lever 51 reciprocates up and down.

An engagement hole 55, which is engaged with the engaging projection 36 arranged on the wiper holder 35, is formed in the other end of the pivot lever 51. The other end of pivot lever 51 pivots up and down, so that the wiper holder 35 reciprocates up and down.

As a result, by the operation of the cam section 56 formed in the cam gear 61, the wiper 27 accommodated in the wiper holder 35 can move up and down between the wiping position where the tip end 27a comes in contact with the nozzle formation face 2a and the retreating position where the tip end 27a is separated from the nozzle formation face 2a.

The sub wiper 30 is held in one end of a pivot arm 32, of which the other end is supported to freely rotate in a spindle 35a projecting in the lower side of the wiper holder 35, and pivots in the widthwise direction of the wiper along the opposite face of the wiper 27. The sub wiper 30 is preferably made of rubber and formed in a blade shape. The front edge of the sub wiper 30 comes in contact with the wiper 27 to scrape it. Accordingly, the sub wiper 30 can scrape foreign matter such as ink adhered to the wiper 27.

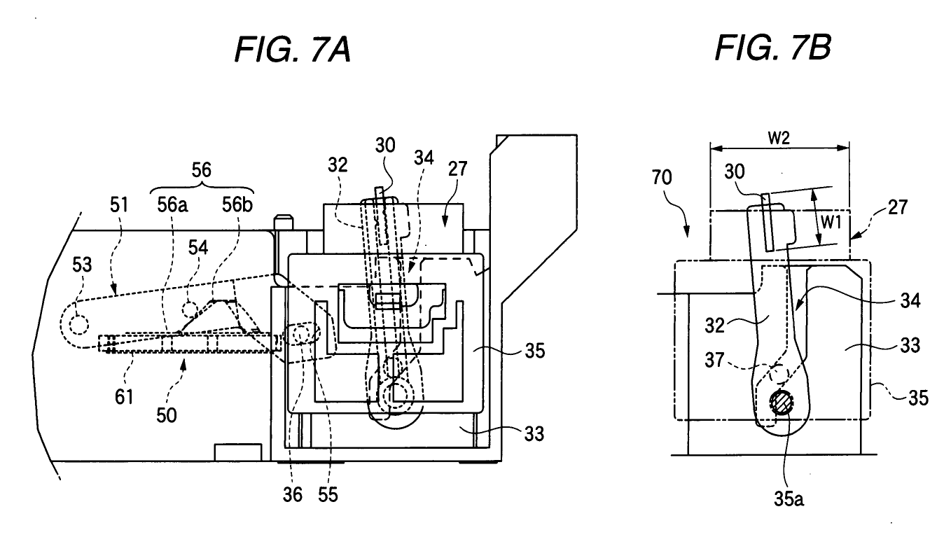

The length of the front edge of the sub wiper 30 preferably is enough to come in contact with the region in a predetermined range from the front end of the wiper 27. The length determines a scraping width W1 of the sub wiper 30 which pivots in the widthwise direction of the wiper (see FIG. 7B). The scraping width W1 of the sub wiper 30 does not need to match the entire width W2 of the wiper 27 corresponding to the nozzle formation face 2a and can be much narrower than the entire width W2 of the wiper 27.

The pivot arm 32 is pivoted to reciprocate in the widthwise direction of the wiper with the wiper holder 35 advancing and retreating back and forth, by an interlocking mechanism 70.

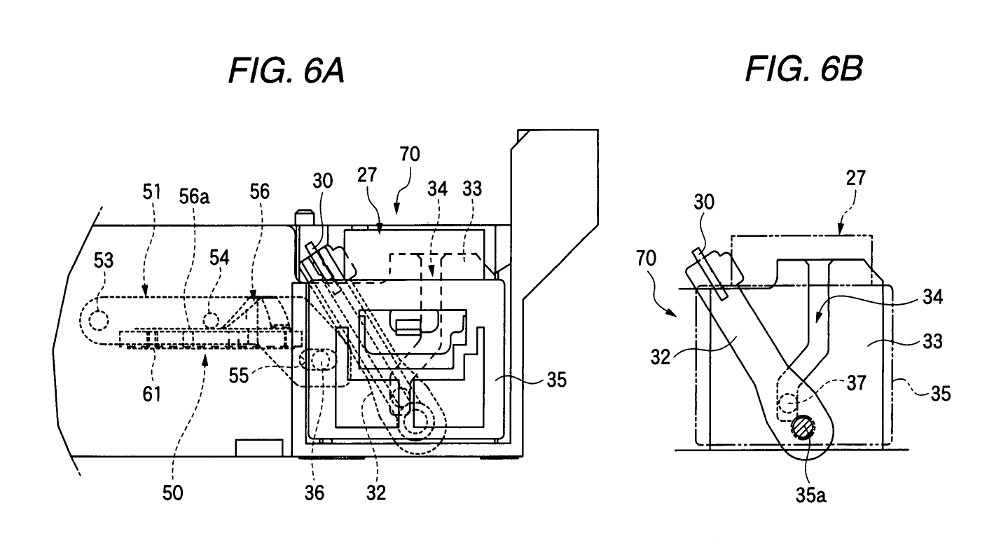

As shown in FIGS. 3, 6A and 6B, the interlocking mechanism 70 includes an engagement projection 37 which projects from the pivot arm 32 and a cam groove 34 which is formed in a partition wall 33 of the wiper housing section 43 to drive and guide the engagement projection 37.

In other words, if the pivot arm 32, which is supported to freely rotate in the spindle 35a of the wiper holder 35, advances and retreats with respect to the wiper housing section 43 along with the wiper holder 35, the engagement projection 37 is driven and guided along the cam groove 34, as shown in FIGS. 6 to 8. Since the cam groove 34 is formed substantially in a crank shape to extend from the lower side to the upper end of the partition wall 33, the pivot arm 32, of which the engagement projection 37 is guided along the cam groove 34, pivots in the widthwise direction of the wiper.

Accordingly, the sub wiper 30, which is held in the pivot end side of the pivot arm 32, pivots in the widthwise direction of the wiper in conjunction with advancing and retreating of the wiper holder 35.

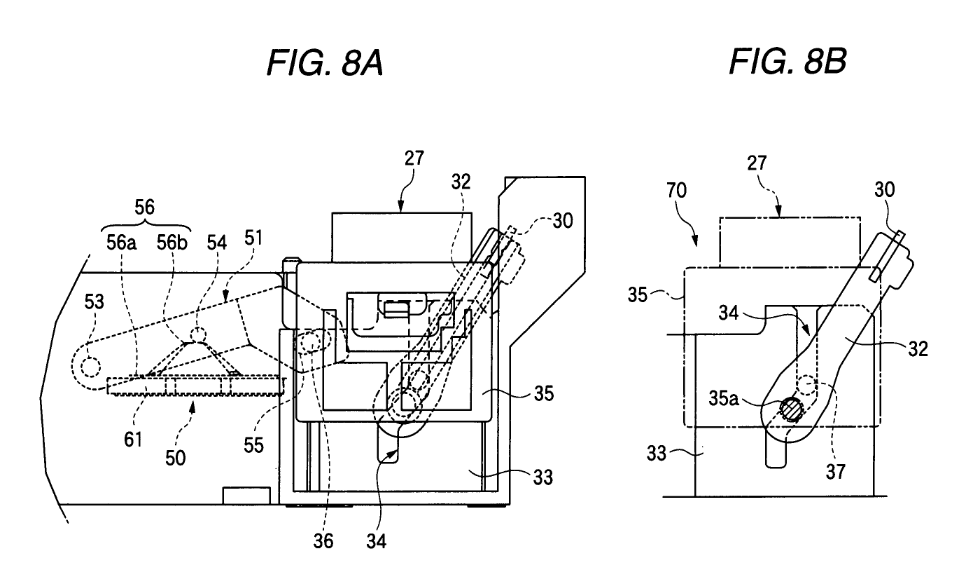

Moreover, a pivotable range of the pivot arm 32 is set so that the wiper 27 moves to the position where the sub wiper 30 held at the pivot end does not interfere with the wiper 27, when the wiper 27 moves to the retreating position (the position shown in FIGS. 6A and 6B) and the wiping position (the position shown in FIGS. 8A and 8B) respectively.

In the head maintenance device 20, the wiper housing section 43 is provided with an absorber 45 for trapping the extraneous matter scattered on an extension line along the moving direction of the sub wiper 30, as shown in FIGS. 2 and 3.

When foreign matter such as ink or the like, which is scraped from the wiper 27 by the sub wiper 30, is scattered, the absorber 45 made of nonwoven fabric or sponge can absorb and trap the foreign matter to prevent it from dirtying the inside of the wiper housing section.

Next, the operation of the head maintenance device 20 will be described with reference to FIGS. 6A through 8B.

First, in an inactive state of the head maintenance device 20, such as when a printer is not used or when printing is performed, the wiper 27 and the sub wiper 30 are positioned in the retreating position, as shown in FIGS. 6A and 6B. In other words, the follower projection 54 of the pivot lever 51 is positioned on the first cam face 56a of the cam section 56 in the cam gear 61, so that the wiper driving mechanism 50 positions the pivot lever 51 in a standby position.

When the head maintenance device 20 operates, the print head 2 mounted on the carriage 1 is positioned in the home position outside the printed region, and the wiper 27 moves from the retreating position to the wiping position.

In other words, if the wiper driving mechanism 50 is driven by the driving force from the pump motor 80 through the power transmission mechanism 60, and the cam gear 61 rotates at a predetermined angle, the follower projection 54 of the pivot lever 51 is placed on the second cam face 56b having a mountain shape, and the pivot lever 51 is rotated upward about the spindle 53, as shown in FIGS. 7A and 7B.

If so, the wiper holder 35, in which the engagement projection 36 is engaged with the engagement hole 55 of the pivot lever 51, moves upward to be displaced from the retreating position to the wiping position, and the pivot arm 32, of which engagement projection 37 is driven and guided by the cam groove 34, pivots in the widthwise direction of the wiper, so that the sub wiper 30 can reciprocate to previously scrape extraneous matter adhered to the wiper 27.

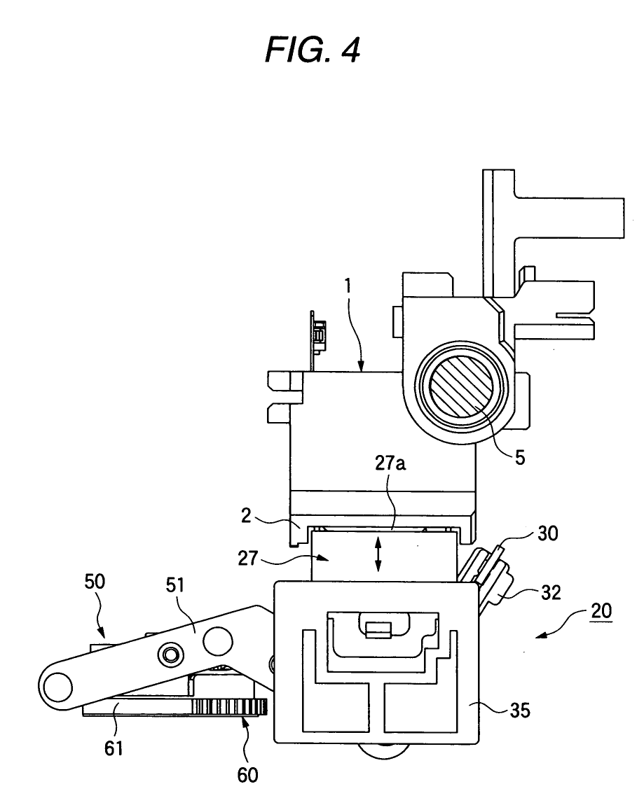

If the follower projection 54 reaches the top of the second cam face 56b as shown in FIGS. 8A and 8B, the wiper holder 35 reaches the wiping position and the sub wiper 30 provided in end of the pivot arm 32 reaches the position (the right-hand side position in the drawing) where the sub wiper 30 does not interfere with the wiper 27. When the wiper holder 35 reaches the wiping position, the tip end 27a of the wiper 27 moves farther upward than the nozzle formation face 2a, as shown in FIGS. 4 and 5.

Next, the carriage driving motor 3 is driven, and the print head 2 moves toward the printed region from the maintenance region outside the printed region (the direction of the arrow in FIG. 5). If so, the wiper 27 abuts on the print head 2, and the tip end 27a thereof bends and transfers foreign matter such as ink adhered to the nozzle formation face 2a to the wiper 27, to remove the foreign matter. At this moment, since the extraneous matter of the wiper 27 was previously scraped by the sub wiper 30, the always clean wiper 27 can scrape the foreign matter adhered to the nozzle formation face 2a.

After the print head 2 moves completely to the printed region, the wiper 27 moves to the retreating position from the wiping position.

In other words, if the wipe driving mechanism 50 is appropriately driven by the driving force from the pump motor 80 through the power transmission mechanism 60, and the cam gear 61 rotates in reverse at a predetermined angle, the follower projection 54 of the pivot lever 51 moves to the first cam face 56a from the second cam face 56b, and the pivot lever 51 rotates downward about the spindle 53.

The wiper holder 35, in which the engagement projection 36 is engaged with the engagement hole 55 of the pivot lever 51, then moves downward to be displaced from the wiping position to the retreating position, while the pivot arm 32, of which the engagement projection 37 is driven and guided along the cam groove 34, also pivots in the widthwise direction of the wiper. Therefore, the sub wiper 30 can reciprocate to scrape extraneous matter such as ink adhered to the wiper 27.

According to the head maintenance device 20 of the present embodiment, the sub wiper 30 moves in the widthwise direction of the wiper (right and left direction in FIG. 2) which is substantially orthogonal to the moving direction of the wiper 27 (up and down direction in FIG. 2), so that extraneous matter adhered to the wiper 27 is scraped. Therefore, the scraping width W1 of the sub wiper 30 does not need to correspond to the entire width W2 of the wiper 27 corresponding to the nozzle formation face 2a and can be made relatively narrow (see FIG. 7B).

Accordingly, even if the sub wiper 30 does not have a high manufacturing accuracy and a high positioning accuracy, the sub wiper 30 can be uniformly contacted with the wiper 27, so that uneven scraping hardly occurs. Therefore, manufacturing costs can be reduced.

In addition, the engagement groove 35a formed at edges of both sides of the wiper holder 35 is engaged with the fitting projection 43a of the wiper housing section 43, so that the wiper holder 35 holding the wiper 27 freely advances and retreats in a state where the wiper holder 35 is reliably slid and guided in the direction orthogonal to the reciprocating direction of the print head 2.

Accordingly, even when the adhered foreign matter is scraped by the sub wiper 30 or even when the tip end 27a comes in contact with the nozzle formation face 2a, the wiper 27 held by the wiper holder 35 which freely advances and retreats does not rattle or vibrate. Therefore, high precision head cleaning can be maintained.

In the head maintenance device 20 of the present embodiment, the configuration for moving the sub wiper 30 in the widthwise direction of the wiper 27 includes the wiper holder 35 for holding the wiper 27, the wiper housing section 43 for accommodating the wiper holder 35, the wiper driving mechanism 50, which advances and retreats the wiper holder 35 with respect to the wiper housing section 43, the pivot arm 32 for rocking the sub wiper 30 in the width-direction of the wiper, which is rotatably supported in the wiper holder 35 to be held at the one end of the wiper holder 35, and the interlocking mechanism 70, which moves the pivot arm 32 in conjunction with advancing and retreating of the wiper holder 35. Accordingly, it is possible to obtain a compact and simple mechanism at a low cost.

Furthermore, the interlocking mechanism 70 can reciprocate the pivot arm 32 in the widthwise direction of the wiper with the wiper holder 35 advancing and retreating.

Consequently, just before the wiper 27 comes in contact with the nozzle formation face 2a of the print head 2, the sub wiper 30 can reciprocate to previously scrape extraneous matter adhered to the wiper 27. Further, immediately after the wiper 27 is separated from the nozzle formation face 2a of the printing head 2, the sub wiper 30 can reciprocate to scrape extraneous matter adhered to the wiper 27, which has wiped the nozzle formation face 2a. The wiper 27 can thus wipe the nozzle formation face 2a of the print head 2 in a state where the wiper 27 is always kept clean.

Accordingly, according to the ink jet printer 10 of the present embodiment, foreign matter on the nozzle formation face 2a of the print head 2 is reliably removed by the head maintenance device 20. and the nozzle formation face 2a is always kept clean, so that clogging of the print head 2 and dot omission can be prevented to obtain a good-quality printed matter.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims. For example, the configuration related to the head maintenance device and the ink jet printer of this invention, which includes the wiper, the sub wiper, the wiper holder, the wiper driving mechanism, and the pivot arm and the interlocking mechanism, is not limited to the configuration of the above-described embodiment. Such variations are intended to be within the scope of this invention.

1. A maintenance device for an ink jet printing head which is reciprocated in a first direction, the maintenance device comprising:
a first wiper positionable to wipe a nozzle formation face of the ink jet printing head, the first wiper extending in a second direction orthogonal to the first direction and being movable in a third direction orthogonal to the first direction and the second direction between a first position being away from the nozzle formation face and a second position being contact with the nozzle formation face; and
a second wiper movable in the second direction to wipe off foreing matter from the first wiper.

2. The maintenance device as set forth in claim 1, further comprising:
a holder movable in the third direction while holding the first wiper;
an arm, a first end of which is pivotably supported on the holder and a second end of which supports the second wiper; and
an interlocking mechanism, which pivots the arm in the second direction in accordance with the movement of the holder in the third direction.

3. The maintenance device as set forth in claim 1, further comprising an ink absorber, disposed adjacent the first wiper to absorb foreign matter wiped from the first wiper by the second wiper.

4. The maintenance device as set forth in claim 1, wherein a longitudinal width of the second wiper is less than a width of the first wiper in the second direction.

5. The maintenance device as set forth in claim 1, wherein the second wiper wipes the first wiper when the first wiper moves from the first position to the second position.

6. The maintenance device as set forth in claim 1, wherein the second wiper wipes the first wiper when the first wiper moves from the second position to the first position.

7. An ink jet printer, comprising:
an ink jet printing head, reciprocated in a first direction and having a nozzle formation face; and
a maintenance device comprising:
a first wiper positionable to wipe the nozzle formation face, the first wiper extending in a second direction orthogonal to the first direction, and being movable in a third direction orthogonal to the first direction and the second direction between a first position being away from the nozzle formation face and a second position being contact with the nozzle formation face; and
a second wiper movable in the second direction to wipe off foreign matter from the first wiper.

8. The maintenance device as set forth in claim 7, wherein a longitudinal width of the second wiper is less than a width of the first wiper in the second direction.

9. A maintenance device for wiping a nozzle formation face of an ink jet printing head, the maintenance device comprising:
a first wiper movable between a first position being in a path of the nozzle formation face and a second position being away from the path; and
a second wiper disposed adjacent the first wiper and reciprocatable from a third position on one side of the first wiper, across the first wiper, to a fourth position on an opposite side of the first wiper,
wherein the first and second wipers are coupled in a dependent relationship such that when the first wiper is moved from the second position to the extended first position, the second wiper is pivoted from the third position across the first wiper to the fourth position.

10. The maintenance device as set forth in claim 9, further comprising:
a holder supporting the first wiper, the holder being movable within a wiper housing to move the first wiper between the first position and the second position, wherein a wall of the wiper housing comprises a cam portion therein; and
a pivot arm pivotally attached at a first end to the holder and supporting the second wiper at a second end, the pivot arm comprising an engagement projection disposed between the first and second ends, wherein the engagement projection is disposed in the cam portion.

11. The maintenance device as set forth in claim 10, further comprising a wiper driving mechanism coupled with the holder, the wiper driving mechanism driving the holder within the wiper housing to move the first wiper between the first position and the second position.

12. The maintenance device as set forth in claim 11, wherein the wiper driving mechanism comprises a pivot lever pivotable about a pivot end and coupled with the holder at an opposite end, the pivot lever including a cam follower engaged with a cam gear having cam surfaces, wherein the cam gear is rotatable to vary a position of the cam follower on the cam surfaces, thereby driving the holder to move the first wiper between the first position and the second position.

13. The maintenance device as set forth in claim 9, wherein the second wiper is configured to wipe the first wiper before and after the first wiper wipes the nozzle formation face of the ink jet printing head.

14. The maintenance device as set forth in claim 9, wherein a longitudinal width of the second wiper is less than a longidudinal width of the first wiper.
